(19) United States
(12) Patent Application Publication
(10) Pub. No.: US 2013/0308810 A1
(43) Pub. Date: Nov. 21, 2013

(54) Speaker

(71) Applicant: Chen-Huan TSENG, Taoyuan County (TW)

(72) Inventor: Chen-Huan TSENG, Taoyuan County (TW)

(21) Appl. No.: 13/475,059

(22) Filed: May 18, 2012

(51) Int. Cl. H04R 1/02

(52) U.S. Cl. 381/334

(57) ABSTRACT

A speaker comprises a main body. The main body is disposed with a central processing unit, an amplifier and a control interface. A music storage medium is connected to the central processing unit and can be controlled via the control interface to play music via the amplifier. The main body is disposed with a flip type cover, and a connector is accommodated inside the cover for being electrically connected with the music storage medium. The connector is connected to the central processing unit of the main body via an elastically retractable connecting line.

### BACKGROUND OF THE INVENTION

1. Field of Invention

The present invention relates to a speaker with a hidden connector. The speaker is structurally simple and convenient to use. The speaker is decoratively presented because of its hidden design when it is not connected to a music storage medium.

2. Related Art

Music played indoors is usually amplified by externally connected speaker for the enjoyment of listeners.

Generally, speaker is disposed with connector for connecting to large sized audio equipment or small sized notebook computer and mobile phone for playing music.

Because technologically and stylishly designed products are more demanded by users, speakers with new design and appearance are continuously introduced by makers in order to attract consumers. It would be ideal if the operation of a speaker is structurally kept while its design and appearance are attractive to consumers.

### SUMMARY OF THE INVENTION

An object of the present invention is to provide a speaker which is structurally simple and convenient to use, and is also technologically and stylishly designed.

In order to achieve the above-mentioned objectives, a speaker of the present invention comprises a main body. The main body is disposed with a central processing unit, an amplifier and a control interface. A music storage medium is connected to the central processing unit and can be controlled via the control interface to play music via the amplifier. The main body is disposed with a flip type cover, and a connector is accommodated inside the cover for being electrically connected with the music storage medium. The connector is connected to the central processing unit of the main body via an elastically retractable connecting line.

In implementation, the main body is disposed with an accommodating space, the flip type cover covers the accommodating space, and a hole is disposed on the main body and above the accommodating space for accommodating the connector.

In implementation, the connector is a USB connector.

In implementation, the music storage medium is a mobile phone.

The present invention will become more fully understood by reference to the following detailed description thereof when read in conjunction with the attached drawings.

### BRIEF DESCRIPTION OF THE DRAWINGS

FIG. 1 is a framework of a speaker according to an embodiment of the present invention;

FIG. 2 is a perspective view of the speaker according to the embodiment of the present invention;

FIG. 3 is a perspective view of the speaker being viewed from another angle according to the embodiment of the present invention;

FIG. 4 is a perspective view of the speaker with a cover being opened and a connector being drawn out according to the embodiment of the present invention; and

FIG. 5 is a perspective view of the speaker being connected with a music storage medium according to the embodiment of the present invention.

### DETAILED DESCRIPTION OF THE INVENTION

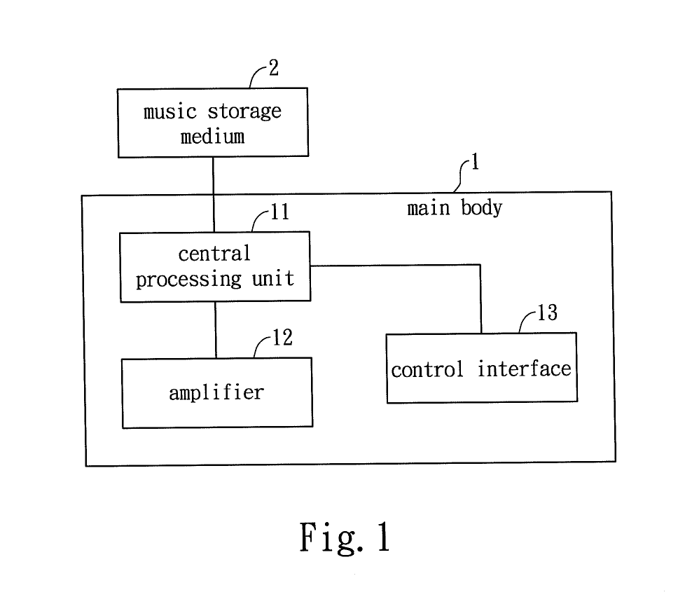

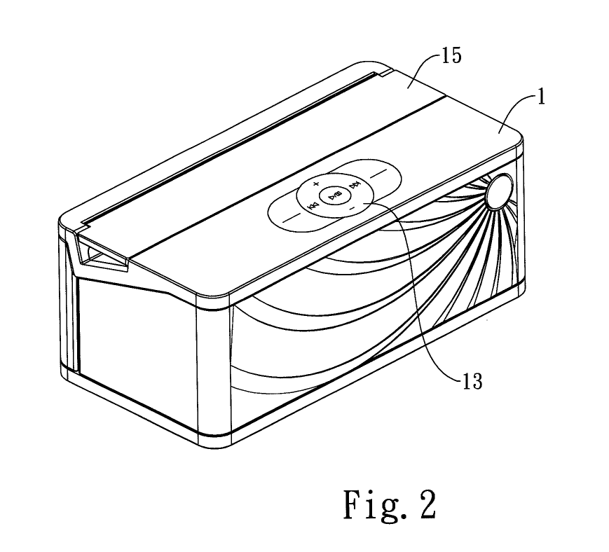

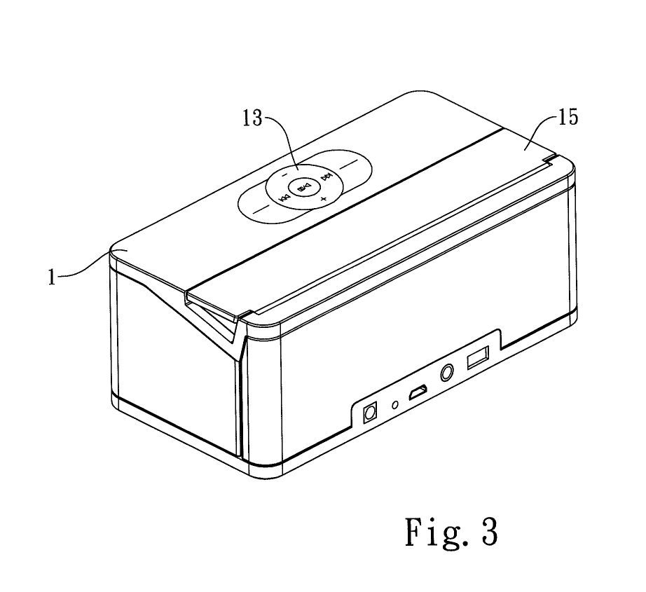

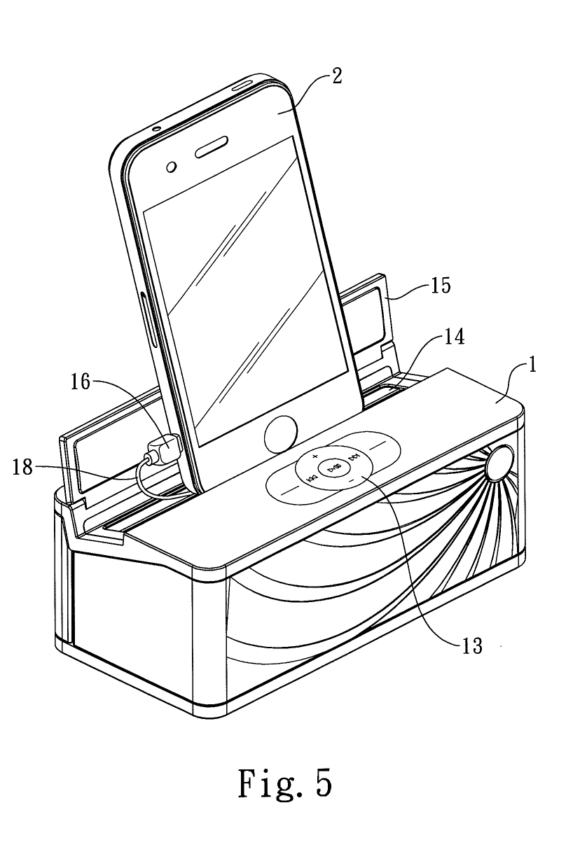

FIGS. 1 to 5 are illustrations of a speaker according to an embodiment of the present invention.

A speaker of the present invention comprises a main body 1. The main body 1 is disposed with a central processing unit 11, an amplifier 12 and a control interface 13. A music storage medium 2 is connected to the central processing unit 11 and can be controlled via the control interface 13 to play music via the amplifier 12.

The main body 1 is disposed with an accommodating space 14, and a flip type cover 15 is disposed above the accommodating space 14 of the main body 1. The flip type cover 15 covers the accommodating space 14. A connector 16 is accommodated inside the cover 15 for being electrically connected with the music storage medium 2. A hole 17 is disposed on the main body 1 and above the accommodating space 14 for accommodating the connector 16. The connector 16 is connected to the central processing unit 11 (not shown in the figures) of the main body 1 via an elastically retractable connecting line 18. The connector 16 is a USB connector and the music storage medium 2 is a mobile phone.

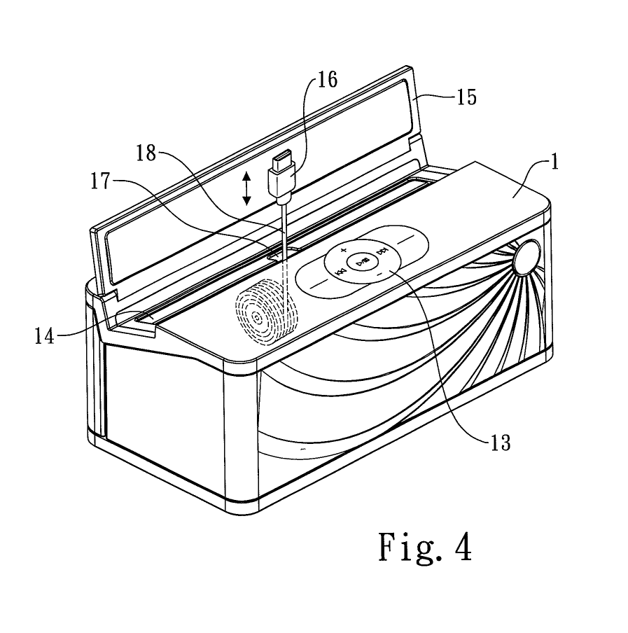

When a user wants to play music, the flip type cover 15 is opened and the USB connector 16 is taken out from the main body 1. The connector 16 is drawn and extended from the main body 1 via the elastically retractable connecting line 18. Regardless of the type of the music storage medium 2 or the disposing position of a connector of the music storage medium 2, the music storage medium 2 can still be electrically connected with the connector 16. After the music storage medium 2 and the connector 16 are connected with each other, the music storage medium 2 can be securely placed above the accommodating space 14 of the main body 1 as shown in FIG. 4. After the usage, the USB connector 16 is detached from the music storage medium 2, and the connector 16 can be retracted inside the accommodating space 14 via the elastically retractable connecting line 18. Finally, the flip type cover 15 is closed and the decoratively designed speaker is presented with the connector 16 being hidden.

Therefore, the speaker of the present invention has the following advantages:

1. The connector of the present invention is hidden inside the flip type cover and the speaker can be used for any types of the music storage medium via the elastically retractable connecting line connected between the connector and the central processing unit. The music storage medium can still be electrically connected with the connector regardless of the disposing position of the connector of the music storage medium.

2. The decoratively designed speaker is presented with the hidden design of the connector.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A speaker, comprising:
a main body, disposed with a central processing unit, an amplifier, and a control interface, where a music storage medium is connected to the central processing unit and is controlled via the control interface to play music via the amplifier, characterized in that:
the main body is disposed with a flip type cover; a connector is accommodated inside the cover for being electrically connected with the music storage medium, and the connector is connected to the central processing unit of the main body via an elastically retractable connecting line.

2. The speaker as claimed in claim 1, wherein the connector is a USB connector.

3. The speaker as claimed in claim 1, wherein the main body has an accommodating space; the flip type cover covers the accommodating space; and a hole is provided on the main body and above the accommodating space for accommodating the connector.

4. The speaker as claimed in claim 3, wherein the connector is a USB connector.

5. The speaker as claimed in claim 1, wherein the music storage medium is a mobile phone.
